(19) United States
(12) Patent Application Publication
(10) Pub. No.: US 2023/0133985 A1
(43) Pub. Date: May 4, 2023

(54) DISPLAY CONTROL DEVICE AND DISPLAY CONTROL METHOD

(71) Applicant: Nippon Telegraph and Telephone Corporation, Tokyo (JP)

(72) Inventors: Sayaka YAGI, Musashino-shi, Tokyo (JP); Kimio TSUCHIKAWA, Musashino-shi, Tokyo (JP); Yuki URABE, Musashino-shi, Tokyo (JP); Takeshi MASUDA, Musashino-shi, Tokyo (JP); Fumihiro YOKOSE, Musashino-shi, Tokyo (JP); Haruo OISHI, Musashino-shi, Tokyo (JP)

(21) Appl. No.: 17/918,161

(22) PCT Filed: May 1, 2020
(86) PCT No.: PCT/JP2020/018413

§ 371 Date: Oct. 11, 2022

(51) Int. Cl. G06T 11/20

(52) U.S. Cl. CPC G06T 11/206

(57) ABSTRACT

A display control apparatus (10) according to an embodiment uses an operation log to generate a graph object indicating a plurality of nodes expressed in a predetermined unit and a node-to-node connection relationship and draws, on the basis of the generated graph object, two or more axes arranged in parallel and a line representing the node-to-node connection relationship between two of the axes to perform screen display.

### TECHNICAL FIELD

The present invention relates to a display control apparatus and a display control method.

### BACKGROUND ART

For an efficient job improvement, an analyzer needs to accurately understand a job status. Conventionally methods have been proposed which allow fine-granular understanding of job status without dependency on individuals in an efficient and extensive manner by acquiring an operation log of a terminal and visualizing it.

Among visualization methods using an operation log, a visualization method where assuming, for example, job, work, or operation as one node, transition between nodes is expressed as a link (hereinafter, a node-and-link display) is known as a method effective in understanding a flow of job, work, or operation. Here, the “operation” refers to an action performed by a user, such as “inputting a customer name” or “pressing a confirmation button”, the “work” refers to a group of operations for carrying out a specific purpose such as “entry to an application system” or “check of a form”, and the “job” refers to a task including a plurality of works, such as “receipt of an application.”

For example, in Non-Patent Literature 1, for an operation log including pieces of information at a plurality of granularities, such as application, window, and operation content, a node-and-link display where each node is an operation is implemented.

Here, in order for a job analyzer to find a problem in a job, it is necessary to understand the job at an appropriate granularity suitable for a purpose of analysis. For example, in a case where the purpose of analysis is to find an inefficient work in a job, it is desirable that the analyzer should perform analysis in a analyzing flow as follows: first understanding in what workflow, works are carried out in a unit of application or a unit of window, then identifying, among the works, a time-consuming work and examining it in a deeper level into a unit of operation.

In order to efficiently perform the job analysis as described above using an operation log, an approach is adopted, where the operation log, which includes pieces of information at a plurality of granularities, such as application, window, and operation, is layered on a granularity basis, thereby listing necessary information to assist in understanding an element-to-element relativeness. For example, in Non-Patent Literature 1, nodes of a node-and-link display are grouped and aggregated, thereby aggregately displaying information at other granularities, such as work, job, and window. Further, as a technology of switching a granularity of nodes to perform display, for example, in Non-Patent Literature 1, the granularity is switched by an operation for expansion/contraction of nodes to change the number and/or locations of the nodes. Further, in Non-Patent Literature 2, child nodes telescopically expanded in a parent node are drawn, which makes it possible to switch the granularity with a layered structure recognized.

Further, in performing job analysis, it is also effective to perform comparison of a procedure for each of a plurality of users or orders (order is a unit for identifying works such as items/directions). This makes it possible to understand, for example, a difference in procedure between a beginner and an expert and/or a feature of a job flow for each order.

For example, in a case where the comparison of a procedure as described above is performed with the node-and-link display as in Non-Patent Literature 1, (1) a method where node-and-link displays as many as the number of elements (users, orders, or the like) wished to be compared are arranged or (2) a method where node-and-link displays with a plurality of elements overlaid are generated and a common part or a difference is highlighted is typically adopted in many cases.

### CITATION LIST

### Non-Patent Literature

Non-Patent Literature 1: Y. Urabe, S. Yagi, K. Tsuchikawa, T. Masuda, Visualizing User Action Data to Discover Business Process, In 2019 20th Asia-Pacific Network Operations and Management Symposium (APNOMS) (pp. 1-4), IEEE, 2019, September.

Non-Patent Literature 2: K. Figl, A. Koschmider, and S. Kriglstein, “Visualising Process Model Hierarchies”, [searched on February 20, Reiwa 2 year], Internet <URL: https://www.researchgate.net/publication/236135460_Visual ising_Process_Model_Hierarchies>

### SUMMARY OF THE INVENTION

### Technical Problem

However, a conventional node-and-link display technology is disadvantageous in that in a case where data of an operation log to be handled is large, a conventional node-and-link display is unlikely to allow a node-to-node connection relationship to be expressed such that a user can easily see it.

For example, for job analysis using an operation log, data to be handled is often large. The background behind this is that optimization for each of departments, projects, or the like for job improvement sometimes unintentionally makes system or management complicated, resulting in a failure in overall optimization. Accordingly, in order to achieve overall optimization, in fact, job status needs to be understood on a company-wide level, and data to be handled involves a larger number of persons and a larger number of jobs. In view of such a fact, in a case where an operation log to be handled is large, a conventional node-and-link display technology is unlikely to allow a node-to-node connection relationship to be expressed such that a user can easily see it.

The present invention has been made in view of the above and an object thereof is to provide a display control apparatus and a display control method that make it possible to intuitively understand a node-to-node connection relationship even though operation log data is large.

### Means for Solving the Problem

To solve the above-described problem and achieve the object, a display control apparatus according to the present invention includes: a generation section configured to use an operation log to generate a graph object indicating a plurality of nodes expressed in a predetermined unit and a node-to-node connection relationship; and a visualization section configured to draw, on a basis of the graph object generated by the generation section, two or more axes arranged in parallel and a line representing the node-to-node connection relationship between two of the axes to perform screen display.

Further, a display control method according to the present invention, which is a display control method that is to be performed by a display control apparatus, includes: a generation step of using an operation log to generate a graph object indicating a plurality of nodes expressed in a predetermined unit and a node-to-node connection relationship; and a visualization step of drawing, on a basis of a graph object generated by the generation step, two or more axes arranged in parallel and a line representing the node-to-node connection relationship between two of the axes to perform screen display.

### Effects of the Invention

According to the present invention, it is possible to intuitively understand a node-to-node connection relationship even though operation log data is large.

### BRIEF DESCRIPTION OF DRAWINGS

FIG. 1 illustrates an example of a functional configuration of a display control apparatus according to an embodiment.

FIG. 2 illustrates an example of data configuration of an operation log.

FIG. 3 is a diagram illustrating a data example of a tree structure.

FIG. 4 is a diagram explaining a process for arranging nodes on two y-axes.

FIG. 5 is a diagram illustrating an example of time-series operations performed by a user.

FIG. 6 is a diagram illustrating an example of a graph object.

FIG. 7 is a diagram illustrating drawing of lines connecting parallel two axes on a basis of a graph object.

FIG. 8 is a diagram of assistance in explaining an analysis example using a generated image.

FIG. 9 is a diagram of assistance in explaining an analysis example for understanding of a connection relationship between a plurality of layers.

FIG. 10 is a diagram of assistance in explaining a process example in a case where a graph is to be generated for each user.

FIG. 11 is a diagram of assistance in explaining a display example in a case where an operation common to users or a characteristic operation is highlighted.

FIG. 12 is a flowchart illustrating a process procedure of a display control process according to an embodiment.

FIG. 13 is a diagram illustrating an example of a computer in which a display control apparatus is to be implemented by executing a program.

### DESCRIPTION OF EMBODIMENTS

A detailed description will be made below on an embodiment of the present invention with reference to the drawings. It should be noted that the embodiment does not limit the present invention. Further, in the illustration in the drawings, the same reference signs are used to refer to the same parts.

### Embodiment

First, description will be made on a display control apparatus according to an embodiment. For an analysis of a job status by a user, the display control apparatus according to the present embodiment uses, for example, an expression method where nodes are arranged on one dimension (on a Y-axis) in sequence, the axis is copied and arranged in parallel, and a node-to-node connection relationship is represented by a line connecting the two axes instead of using a conventional node-and-link display where nodes and links are arranged on a two-dimensional plane. The arrangement on one dimension makes it easier to understand a node-to-node connection relationship than the arrangement on the two-dimensional plane, so that the display control apparatus according to the present embodiment can visualize an image that makes a node-to-node connection relationship intuitively understandable even though operation log data is large.

### Configuration of Display Control Apparatus

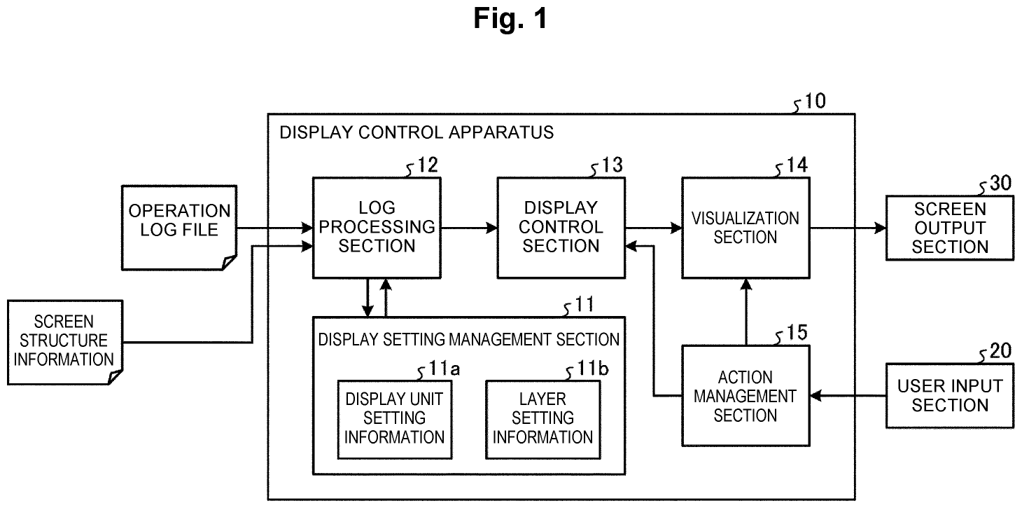

FIG. 1 illustrates an example of a functional configuration of the display control apparatus according to the embodiment. As illustrated in FIG. 1, a display control apparatus 10 according to the present embodiment is connected to a user input section 20 that receives an operation from an analyzer and a screen output section 30 that outputs a screen. It should be noted that the user input section 20 and the screen output section 30 may be included in the display control apparatus 10 or may be included in the same apparatus or different apparatuses. The display control apparatus 10 receives input of an operation log file and screen structure information. The screen structure information is information including application name, window title, and information regarding all the operation targets (identifies of GUI (Graphical User Interface) components) included in the window.

The operation log file includes information logs in a plurality of operation units. Examples of the operation logs include terminal information, log-in user information, application information, window information, operation content, and information indicating a time of occurrence. Examples of the window information include a window title, a URL/file path, and a window handle. The operation content, examples of which include an operation target, an operation type, a value, and a capture image, is recorded in response to occurrence of an operation on an object within the window.

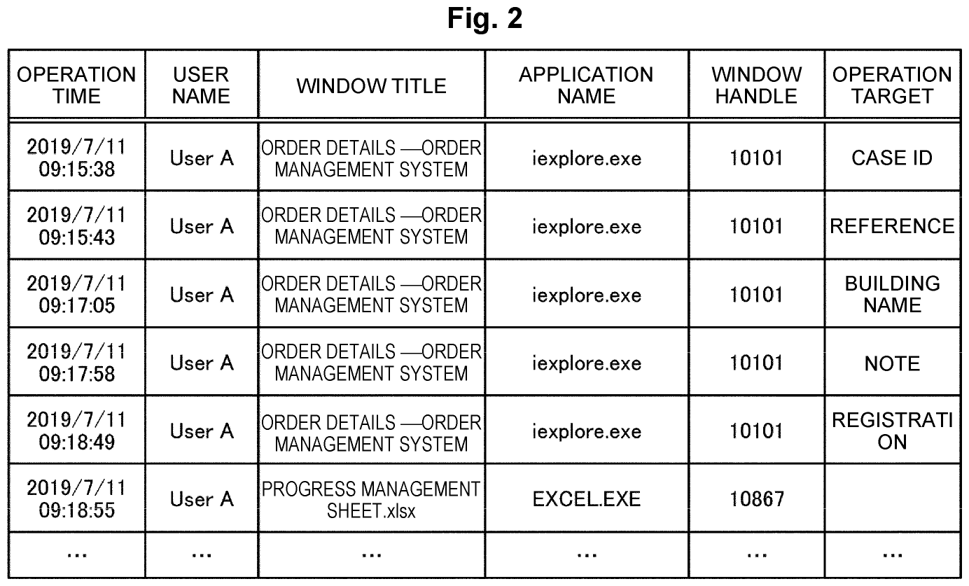

FIG. 2 illustrates an example of data configuration of the operation log. As illustrated in FIG. 2, the operation log is information that records, in response to a change of a window state on a terminal screen, window-based information recording a user operation time on the window, a user name, a window title of an operation target, a name of an application used on the window, and a window handle.

In addition, the operation log further includes an operation time on an object recorded in response to occurrence of an operation on an object within the window and information regarding an operation target. The operation target is an identifier of a GUI component included within an operation target window. Although an item name appears in the example in FIG. 2, the operation target may be, for a browser, an ID or NAME attribute or may be, for a window that is not changeable in screen structure, coordinate information. In addition to the above, the operation log may include information recording operation-based information such as a capture image of a window operated at the operation time, an operation type, and a value inputted by the operation.

The display control apparatus 10 is implemented, for example, when a predetermined program is read in a computer or the like including a ROM (Read Only Memory), a RAM (Random Access Memory), a CPU (Central Processing Unit), etc. and the CPU executes the predetermined program. Further, the display control apparatus 10 includes a communication interface that performs transmission and reception of a variety of information to and from another apparatus connected through a network or the like. For example, the display control apparatus 10 includes an NIC (Network Interface Card) or the like and performs communication with another apparatus through an electric communication line such as a LAN (Local Area Network) or the Internet. The display control apparatus 10 includes a display setting management section 11, a log processing section 12, a display control section (a generation section) 13, a visualization section 14, and an action management section 15.

The display setting management section 11 records display unit setting information 11a and layer setting information 11b. The display setting management section 11 is implemented by a semiconductor memory device, such as a RAM (Random Access Memory) or a flash memory (Flash Memory), or a storage, such as a hard disk or an optical disk. Each of the display unit setting information 11a and the layer setting information 11b, which is setting information set in advance, may be information that is manually or automatically changeable.

The display unit setting information 11a is information for classifying the operation log to generate event data. For example, the display unit setting information 11a is information that indicates a unit in which it is desire to perform comparison, such as user, order, or step, which is information to be referred to by the later-described log processing section 12.

The layer setting information 11b is information for generating a layered structure of nodes (a tree structure) from the operation log. For example, layer setting information 11b is information indicating the item names of layers and an order thereof, which is information to be referred to by the later-described log processing section 12.

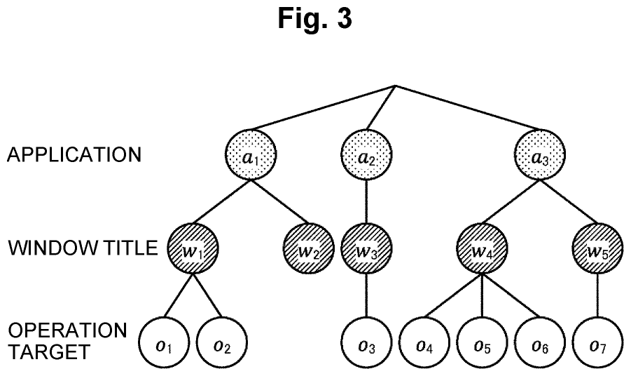

The log processing section 12 generates data indicating the layered structure (the tree structure) for each of the nodes on the basis of the data items included in the operation log. For example, the log processing section 12 generates the tree structure of the nodes on the basis of the data items included in the operation log with reference to the layer setting information 11b. In a case where the layered structure including an application, a window title, and an operation target is set, the log processing section 12 generates an object where the data items are nested as keys, thereby generating data of a tree structure illustrated by way of example in FIG. 3. FIG. 3 is a diagram illustrating a data example of the tree structure.

Further, the log processing section 12 generates event data including an object where the operation log is classified in a display unit (for example, a user unit) set in advance. For example, the log processing section 12 sorts logs by using the display unit as a key on the basis of the display unit setting information 11a and generates event data including the sorted objects. It should be noted that the log processing section 12 arranges the objects included in the event data in a time-series order.

The display control section 13 uses the operation log to generate a graph object indicating a plurality of nodes expressed in a predetermined unit (for example, layer, granularity) and a node-to-node connection relationship. For example, the display control section 13 uses data having the layered structure generated by the log processing section 12 to generate a graph object indicating a plurality of nodes expressed in a predetermined unit (for example, an operation-target unit, a window-title unit, an application unit, or the like) and a node-to-node connection relationship. It should be noted that the above-described predetermined unit is a unit that can be set or changed by a user and a later-described granularity of the graph can be switched by setting or changing this unit.

Further, in a case where the event data is generated by the log processing section 12, the display control section 13 may determine the number of axes on the basis of the number of objects and generate a graph object in each of display units (for example, a user unit) by using the event data generated by the log processing section 12. For example, the display control section 13 determines locations of nodes on Y-axes on the basis of the layered structure, determines the number of the Y-axes (a slot number+1) on the basis of the number of the objects in the event data, and generates a graph object including node information and link information from the event data.

The visualization section 14 draws, on the basis of the graph object generated by the display control section 13, two or more axes arranged in parallel and a line representing the node-to-node connection relationship between two of the axes and outputs them to the screen output section 30 to perform screen display.

The action management section 15 receives user input responsive to a drawn result from the user input section 20 and determines whether or not the operation requires a change of the layer of the display target. The action management section 15 notifies, in response to a change of the layer of the display target being required, the display control section 13 of a change of the display target, whereas notifying, in response to a change of the layer being not required (highlighting the link, or the like), the visualization section 14 of an object that is the operation target.

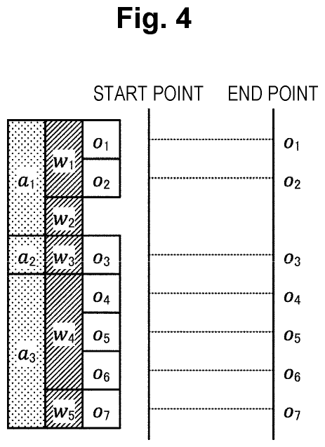

Here, description will be made on a process for arranging nodes on two Y-axes with reference to FIG. 4. FIG. 4 is a diagram of assistance in explaining the process for arranging nodes on the two y-axes. As described with reference to an example in FIG. 4, with two Y-axes representing start point and end point being arranged in parallel, the display control section 13 determines locations of nodes on the Y-axes. Specifically, the display control section 13 divides the Y-axes into the number of leaf nodes and determines the locations on the Y-axes (in FIG. 4, broken lines connecting the axes represent the respective locations of operation targets).

Further, the locations on the Y-axes within each layer are to be determined in a predetermined order. For example, for operation-unit-based nodes, the locations are determined in accordance with the location of a GUI that is an operation target or determined such that a main flow becomes closer. It should be noted that in determining the locations of operation-unit-based nodes on the Y-axes, windows with a large number of element-to-element connections may be placed adjacent to each other to prevent a large number of long links from occurring between windows where transition is frequently performed, thereby causing a link between windows where transition is unlikely to be performed to be elongated to be noticeable.

It should be noted that any method is applicable as an expression method of the layered structure. For example, the layered structure may have layers expressed in the form of Icicle plots expressed as rectangles as illustrated on a left side in FIG. 4 or may be displayed as a list in a manner where upper layers have identical elements adjacent to each other only at the lowermost layer (for example, an operation target).

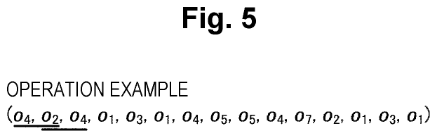

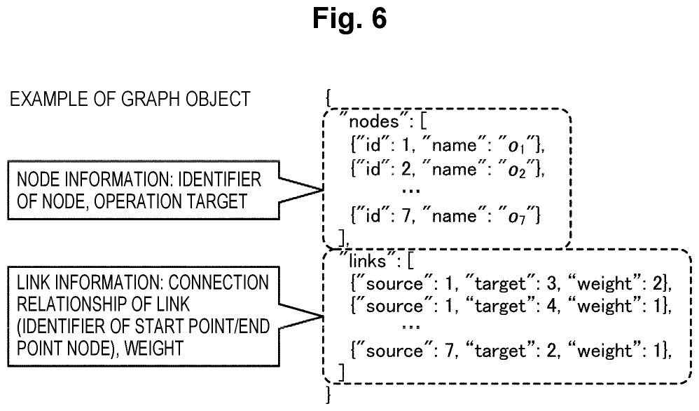

Here, with use of examples in FIG. 5 and FIG. 6, description will be made on a process that is to be performed by the display control section 13 to generate, for a layer that is a drawing target, a graph object from continuous two elements. The layer that is the drawing target here is the lowermost layer “operation target.” Description will be made by way of example on a case where the display control section 13 sequentially extracts continuous two elements from an operation sequence and generates a graph object. FIG. 5 is a diagram illustrating an example of time-series operations performed by a user. FIG. 6 is a diagram illustrating an example of a graph object.

The display control section 13 generates a graph object illustrated by way of example in FIG. 6 from the operation sequence in FIG. 5. As illustrated by way of example in FIG. 6, the display control section 13 generates, as the graph object, a graph object including an ID, which is an identification of a node, and a name of the operation target as node information regarding each of nodes O₁ to O₇. The display control section 13 also generates, as link information indicating a node-to-node connection relationship, a graph object including an ID of a start-point node, an ID of an end-point node, and a weight. Here, the weight refers to the number of links having the same start-point node and end-point node (a frequency of appearance of an operation sequence); however, time required for operation transition or the like can also be set as the weight.

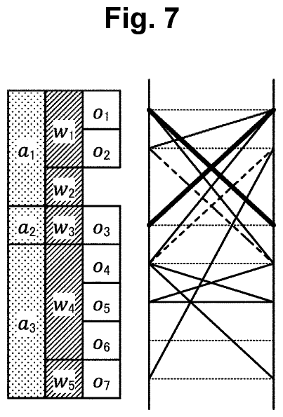

In a case where there are a plurality of links having the same start point and end point, the visualization section 14 draws a line with a thickness depending on a weight (for example, the number of the same links) corresponding to the start point and the end point to perform screen display. Here, with use of FIG. 7, description will be made on a process for drawing a line representing a node-to-node connection relationship between the parallel two axes illustrated by way of example in FIG. 4. FIG. 7 is a diagram illustrating drawing of lines connecting the parallel two axes. The visualization section 14 draws a line connecting the parallel two axes on the basis of a graph object as illustrated by way of example in FIG. 7. Further, when a value of the weight included in the link information regarding the graph object is larger, the visualization section 14 draws a thicker line. It should be noted that the visualization section 14 may color and/or draw a line that satisfies predetermined conditions as a dotted line, a chain line, or the like.

Thus, the display control apparatus 10 uses an expression method where nodes are arranged on one dimension (on a Y-axis) in sequence, the axis is copied and arranged in parallel, and a node-to-node connection relationship is represented by a line connecting the two axes instead of using a conventional node-and-link display where nodes and links are arranged on a two-dimensional plane. Therefore, by virtue of the arrangement on one dimension being easier to read than the arrangement on the two-dimensional plane, the display control apparatus 10 enables intuitive understanding of the connection relationship of large operation log data.

Further, the display control apparatus 10 may generate data having a layered structure by using screen structure information including, for example, an application name, a window title, and information regarding all the operation targets (identifiers of GUI components) included in the window and arrange all the operation targets on the Y-axes.

In such a case, the display control apparatus 10 determines, for all the operation targets, the locations of nodes on the Y-axes on the basis of the generated data having the layered structure, generates a graph object on the basis of the operation log, and draws a line connecting the parallel two axes. Specifically, the log processing section 12 uses, in addition to the operation log, the screen structure information including an application name, a window title, and information regarding all the operation targets included in the window to generate data indicating a layered structure for each of the nodes. The display control section 13 uses the data generated by the log processing section 12 to generate a graph object indicating a plurality of nodes expressed in a predetermined unit and a node-to-node connection relationship. The visualization section 14 uses the graph object generated by the display control section 13 to draw two or more axes arranged in parallel and a line representing the node-to-node connection relationship corresponding to the operation target to perform screen display.

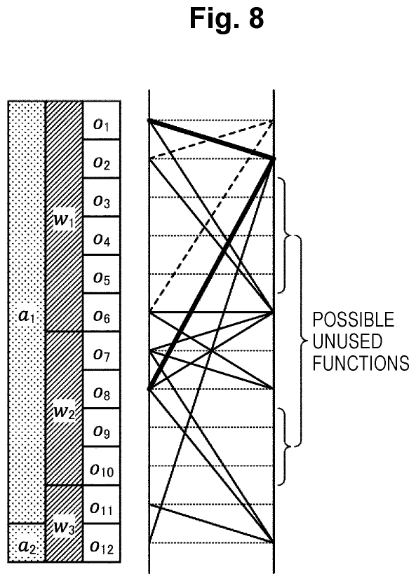

Therefore, in the display control apparatus 10, nodes are arranged for all the operation targets including an operation target not having been performed, which allows a user to easily understand a possible unused function as illustrated by way of example in FIG. 8. FIG. 8 illustrates by way of example a case where operation targets of O₃, O₄, O₅, O₉, and O₁₀ are not used. FIG. 8 is a diagram of assistance in explaining an analysis example using a generated image. For example, a user focuses a node group to which a link is not connected, thereby being able to identify an unused function and determine whether or not the function is necessary in remodeling the system.

Further, in arranging, the user arranges nodes in an order of arrangement of GUIs on the window on the basis of the screen structure information and focuses inclination and orientation of a line representing an operation within a specific window, thereby being able to confirm reasonability of the arrangement of the GUIs. In other words, it can be confirmed whether or not, for example, an input screen designed to be operated from up to down or from left to right is operated in accordance with design intent, or the like. For example, in a case where there is a link extending from lower left to upper right as a link represented by a broken line in FIG. 8 in the input screen, it is speculated that the input screen is operated in an order against design intent.

Further, the display control apparatus 10 may be able to display connection relationships at a plurality of layers with display granularities thereof switched. For example, the display control apparatus 10 receives settings defining which granularity among an application unit, a window-title unit, and an operation unit is applied to perform display and performs bundling of links in a case where a line representing a node-to-node connection relationship is drawn at a granularity of an upper layer (an application unit or a window-title unit) other than the lowermost layer. In this case, for example, in expressing a connection relationship at an upper layer by using the graph object generated by the display control section 13, the visualization section 14 draws, for lines having the same start point and end point at a lower layer, lines bundled in a predetermined display manner.

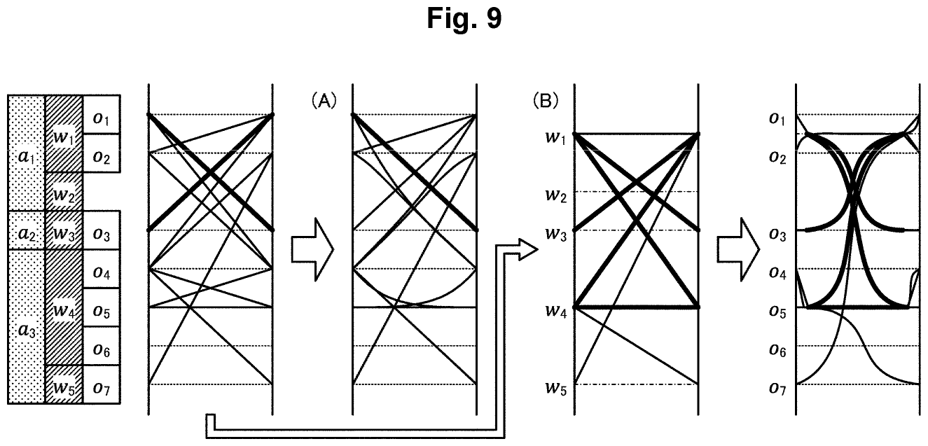

Here, with use of an example in FIG. 9, description will be made on an analysis example for understanding a connection relationship between a plurality of layers. FIG. 9 is a diagram of assistance in explaining an analysis example for understanding of a connection relationship between a plurality of layers. For example, the display control apparatus 10 generates a graph object in a unit where a user wishes to perform bundling. The display control apparatus 10 then performs, for nodes having the same start point and end point in the generated graph object, bundling of links connected to subordinate child nodes (for example, nodes that are operation targets). The bundling here refers to a process for transforming or integrating links so that a link group connected to adjacent nodes is smoothly bundled and visualized.

Regarding a drawing method for bundling, for example, the visualization section 14 may perform drawing such that links in the same direction appear to come together (for example, links having the same start point and end point may be bundled at a middle point) as illustrated by way of example in (A) in FIG. 9 or bundled lines may be drawn between parent nodes with only terminal points connected to child nodes as illustrated by way of example in (B) in FIG. 9. It should be noted that although illustration is omitted, in order that connection destinations of links can be easily seen, gradation may be applied such that terminal points of the links are colored differently for values of respective parent nodes. It should be noted that any method for bundling other than the above-described technique may be applied.

Further, the display control apparatus 10 may be able to generate respective graphs in units such as user, order, and step and arrange them side by side for comparison. For example, the display control section 13 of the display control apparatus 10 sorts logs in each of units for comparison, such as user, order, and step, on the basis of the display unit setting information. It should be noted that for order, step, etc., labels for identification are currently assigned to logs. The display control section 13 then determines, on the basis of the number of objects (the number of slots) in the event data, the number of slots+1 as the number of axes.

Then, with use of respective graph objects in the display units generated by the display control section 13, the visualization section 14 draws axes arranged in parallel as many as the number determined by the display control section 13 and a line representing a node-to-node connection relationship between two of the axes to perform screen display.

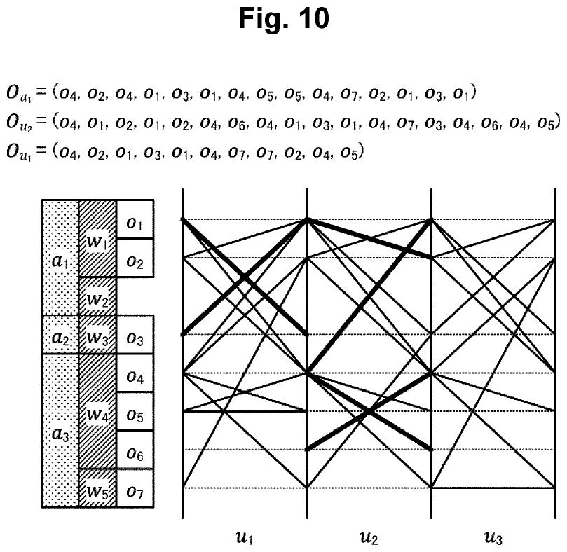

With use of, for example, FIG. 10, description will be made on a process example in a case where a graph is to be generated for each user. FIG. 10 is a diagram of assistance in explaining a process example in a case where a graph is to be generated for each user. As illustrated by way of example in FIG. 10, the display control section 13 classifies the operation log for each of users u₁, u₂, and u₃ and determines the number of axes as “4.” Then, with use of respective graph objects in the display units generated by the display control section 13, the visualization section 14 draws four axes such that they are arranged in parallel in an x-axis direction and draws a link representing a node-to-node connection relationship in a region surrounded by each two of the axes.

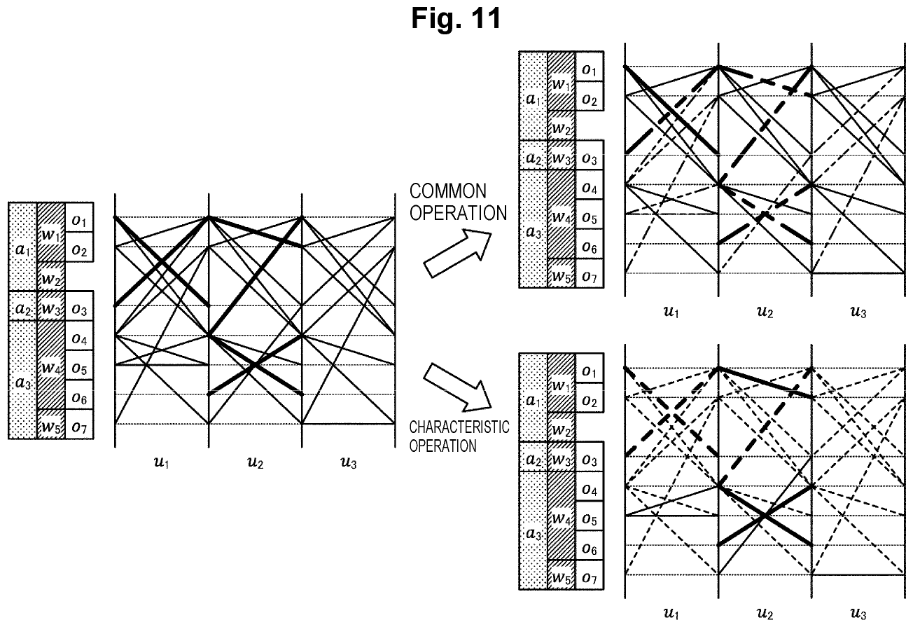

Further, in the graph illustrated by way of example in FIG. 10, the display control apparatus 10 may highlight any operation common between users or characteristic operation. Here, with use of FIG. 11, description will be made on a display example in a case where an operation common between users or a characteristic operation is highlighted. FIG. 11 is a diagram of assistance in explaining a display example in a case where an operation common between users or a characteristic operation is highlighted.

For example, as illustrated by way of example in FIG. 11, the display control apparatus 10 may highlight an operation common to a predetermined number or more of users as a common operation within a graph object corresponding to each of the graphs or may highlight an operation observed only among users the number of which is smaller than the predetermined number as a characteristic operation. It should be noted that in the example in FIG. 11, solid lines represent highlighted links and dotted lines represent the other links. It should be noted that a highlighting manner may be any method and, for example, a link may be colored or a link may be drawn as a dotted line, a chain line, or the like.

### Process Procedure of Display Control Process

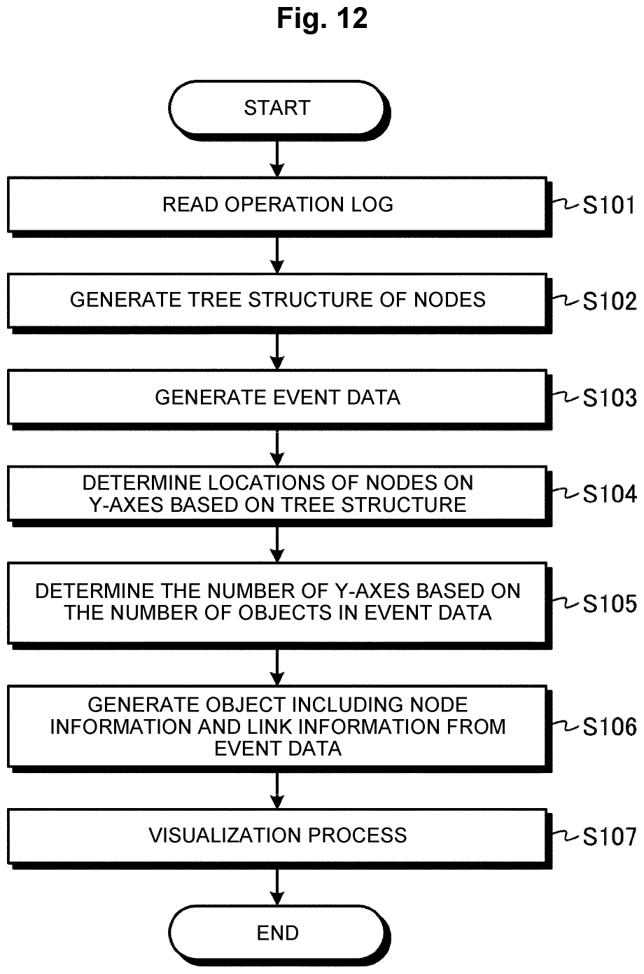

Next, referring to FIG. 12, description will be made on an example of a process procedure of a display control process that is to be performed by the display control apparatus 10. FIG. 12 is a flowchart illustrating a process procedure of a display control process according to an embodiment.

As illustrated by way of example in FIG. 12, the log processing section 12 of the display control apparatus 10 reads the operation log, which is a display target (Step S101). The log processing section 12 then generates a tree structure of nodes on the basis of data items included in the operation log (Step S102).

Subsequently, the log processing section 12 generates event data including an object where the operation log is classified in accordance with the display units (Step S103). The display control section 13 then determines the locations of the nodes on the Y-axes on the basis of the tree structure (Step S104).

Subsequently, the display control section 13 determines the number of the Y-axes on the basis of the number of objects within the event data (Step S105) and generates a graph object including node information and link information from the event data (Step S106).

Subsequently, the visualization section 14 draws, on the basis of the graph object generated by the display control section 13, two or more axes arranged in parallel and a line representing the node-to-node connection relationship between two of the axes and outputs them to the screen output section 30, thus performing a visualization process for outputting screen data (Step S107).

### Effects of Embodiment

As described above, the display control apparatus 10 according to the embodiment uses an operation log to generate a graph object indicating a plurality of nodes expressed in a predetermined unit and a node-to-node connection relationship and draws, on the basis of the generated graph object, two or more axes arranged in parallel and a line representing the node-to-node connection relationship between two of the axes to perform screen display. The display control apparatus 10 thus enables intuitive understanding of the node-to-node connection relationship even though the operation log data is large.

In other words, the display control apparatus 10 uses an expression method where nodes are arranged on one dimension (on a Y-axis) in sequence, the axis is copied and arranged in parallel, and a node-to-node connection relationship is represented by a line connecting the two axes instead of using a conventional node-and-link display where nodes and links are arranged on a two-dimensional plane. Therefore, by virtue of the arrangement on one dimension being easier to read than the arrangement on the two-dimensional plane, the display control apparatus 10 enables intuitive understanding of the connection relationship of large operation log data.

Further, in a conventional technology, switching of the granularity is achieved by an operation for expansion/contraction of the nodes and the number but the switching causes the number and locations of the nodes to change (for example, see Non-Patent Literature 1). Further, in a conventional technology, the granularity can be switched with a layered structure recognized by drawing child nodes telescopically expanded in a parent node but the switching causes the size and the whole location of the parent node to change (for example, see Non-Patent Literature 2). In contrast, the display control apparatus 10 does not cause a change of the number, size, and locations of the nodes with switching of the granularity, thus allowing for maintaining a mental map of an analyzer before and after the switching of the granularity. In other words, by virtue of the locations on the Y-axes being fixed, association of the nodes is easy even though the layer is switched. It should be noted that the mental map refers to a map built in a head of a user while looking at a graph.

Further, in taking an overview of layers except the lowermost layer in order to understand a connection relationship of a plurality of layers, the display control apparatus 10 performs bundling of the links on the basis of the connection relationship of focused one of the layers, thus allowing the connection relationship to be more easily seen.

Further, in order to compare a plurality of users, orders, steps, or the like, the display control apparatus 10 expresses one user, one order, one step, or the like as a region surrounded by two of the axes with the plurality of axes being arranged in parallel in the X-axis direction, thus allowing for easily comparing the connection relationships of the nodes of the plurality of users, the plurality of orders, or the plurality of steps.

### Regarding System Configuration of Embodiment

The components of the display control apparatus 10 illustrated in FIG. 1 are functionally conceptual and are not necessarily physically configured as illustrated in the drawing. In other words, the specific form of distribution and integration of the functions of the display control apparatus 10 is not limited to that illustrated in the drawing and all or part thereof can be distributed or integrated functionally or physically in desired units in accordance with a variety of loads, the state of use, or the like.

All or desired part of the processes that are to be performed by the display control apparatus 10 may be implemented by a CPU, a GPU (Graphics Processing Unit), and a program analyzed and executed by the CPU or the GPU. Further, the processes that are to be performed by the display control apparatus 10 may be implemented as hardware by wired logic.

All or part of the processes described as automatically performed processes among the processes described in the present embodiment may be performed manually. Alternatively, all or part of the processes described as manually performed processes may be performed automatically by a known method. In addition, the above-described and illustrated process procedures, control procedures, specific names, and information including a variety of data and parameters can be changed if necessary unless otherwise specified.

### Program

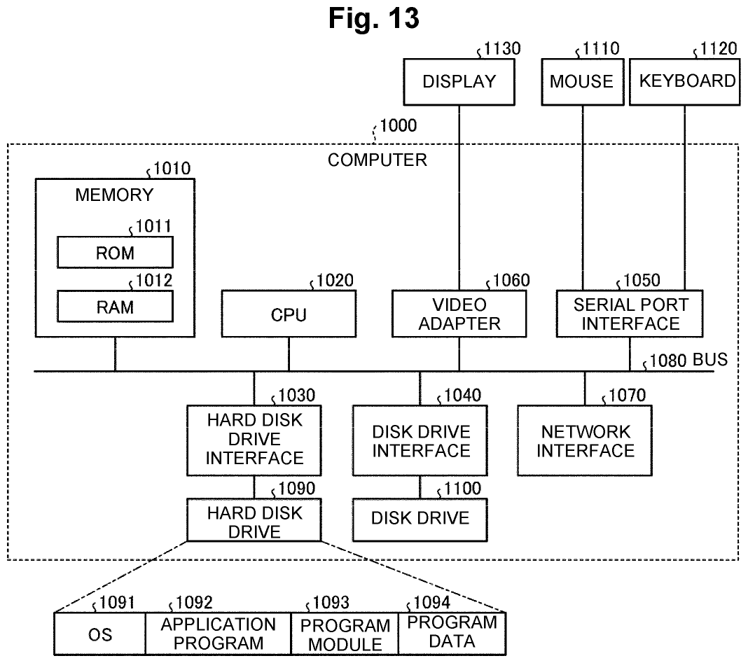

FIG. 13 is a diagram illustrating an example of a computer in which the display control apparatus 10 is to be implemented by executing a program. A computer 1000 includes, for example, a memory 1010 and a CPU 1020. The computer 1000 also includes a hard disk drive interface 1030, a disk drive interface 1040, a serial port interface 1050, a video adapter 1060, and a network interface 1070. These components are connected through a bus 1080.

The memory 1010 includes a ROM 1011 and a RAM 1012. For example, a boot program such as a BIOS (Basic Input Output System) is stored in the ROM 1011. The hard disk drive interface 1030 is connected to a hard disk drive 1090. The disk drive interface 1040 is connected to a disk drive 1100. For example, a removal storage medium such as a magnetic disk or an optical disk is inserted in the disk drive 1100. The serial port interface 1050 is connected to, for example, a mouse 1110 and a keyboard 1120. The video adapter 1060 is connected to, for example, a display 1130.

For example, an OS (Operating System) 1091, an application program 1092, a program module 1093, and program data 1094 are stored in the hard disk drive 1090. In other words, a program that defines the processes of the display control apparatus 10 is implemented as the program module 1093 where a code executable by the computer 1000 is written. The program module 1093 is stored in, for example, the hard disk drive 1090. For example, the program module 1093 for performing a process comparable to the functional configuration of the display control apparatus 10 is stored in the hard disk drive 1090. It should be noted that the hard disk drive 1090 may be replaced by an SSD (Solid State Drive).

Further, setting data that is to be used for the processes of the above-described embodiment is stored as the program data 1094 in, for example, the memory 1010 and/or the hard disk drive 1090. The CPU 1020 then reads the program module 1093 and/or the program data 1094, which is stored in the memory 1010 and/or the hard disk drive 1090, into the RAM 1012 and executes it, if necessary.

It should be noted that instead of being stored in the hard disk drive 1090, the program module 1093 and the program data 1094 may be stored in, for example, a removable storage medium and read by the CPU 1020 via the disk drive 1100 or the like. Alternatively, the program module 1093 and the program data 1094 may be stored in another computer connected through a network (LAN (Local Area Network), a WAN (Wide Area Network), or the like). Then, the program module 1093 and the program data 1094 may be read by the CPU 1020 from the other computer via the network interface 1070.

Although the embodiment to which the invention made by the present inventor is applied is described hereinbefore, the present invention is by no means limited by the description and the drawings, which are part of the disclosure of the present invention by the present embodiment. In other words, other embodiments, practical examples, operational technologies, etc. that are provided by those skilled in the art or the like on the basis of the present embodiment are all within the scope of the present invention.

### REFERENCE SIGNS LIST

10 Display control apparatus
11 Display setting management section
11a Display unit setting information
11b Layer setting information
12 Log processing section
13 Display control section
14 Visualization section
15 Action management section
20 User input section
30 Screen output section

1. A display control apparatus comprising:
a generation section, including one or more processors, configured to use an operation log to generate a graph object indicating a plurality of nodes expressed in a predetermined unit and a node-to-node connection relationship; and
a visualization section, including one or more processors, configured to draw, on a basis of the graph object generated by the generation section, two or more axes arranged in parallel and a line representing the node-to-node connection relationship between two of the axes to perform screen display.

2. The display control apparatus according to claim 1, wherein in a case where there are lines having same start point and end point, the visualization section is configured to draw the line with a thickness depending on a weight corresponding to the start point and the end point to perform screen display.

3. The display control apparatus according to claim 1, further comprising a log processing section, including one or more processors, configured to generate data indicating a layered structure for each of the nodes on a basis of a data item included in the operation log, wherein
the generation section is configured to use the data generated by the log processing section to generate a graph object indicating a plurality of nodes expressed in a predetermined unit and a node-to-node connection relationship, and
in expressing a connection relationship at an upper layer by using the graph object generated by the generation section, the visualization section is configured to draw, for lines having same start point and end point at a lower layer, lines bundled in a predetermined display manner.

4. The display control apparatus according to claim 1, further comprising a log processing section, including one or more processors, configured to generate event data including an object where the operation log is classified in accordance with display units set in advance, wherein
the generation section is configured to determine a number of the axes on a basis of a number of the object and use the event data generated by the log processing section to generate the graph object in each of the display units, and
the visualization section is configured to use the graph object in each of the display units generated by the generation section to draw axes arranged in parallel as many as the number determined by the generation section and a line representing a node-to-node connection relationship between two of the axes to perform screen display.

5. The display control apparatus according to claim 1, further comprising a log processing section, including one or more processors, configured to use, in addition to the operation log, screen structure information including an application name, a window title, and information regarding all of operation targets included in the window to generate data indicating a layered structure for each of the nodes, wherein
the generation section is configured to use the data generated by the log processing section to generate a graph object indicating a plurality of nodes expressed in a predetermined unit and a node-to-node connection relationship, and
the visualization section is configured to use the graph object generated by the generation section to draw two or more axes arranged in parallel and a line representing the node-to-node connection relationship corresponding to each of the operation targets to perform screen display.

6. A display control method that is to be performed by a display control apparatus, the method comprising:
using an operation log to generate a graph object indicating a plurality of nodes expressed in a predetermined unit and a node-to-node connection relationship; and
drawing, on a basis of the graph object, two or more axes arranged in parallel and a line representing the node-to-node connection relationship between two of the axes to perform screen display.

7. The display control method according to claim 6, comprising:
in a case where there are lines having same start point and end point, drawing the line with a thickness depending on a weight corresponding to the start point and the end point to perform screen display.

8. The display control method according to claim 6, further comprising:
generating data indicating a layered structure for each of the nodes on a basis of a data item included in the operation log;
using the data to generate a graph object indicating a plurality of nodes expressed in a predetermined unit and a node-to-node connection relationship; and
in expressing a connection relationship at an upper layer by using the graph object, drawing, for lines having same start point and end point at a lower layer, lines bundled in a predetermined display manner.

9. The display control method according to claim 6, further comprising:
generating event data including an object where the operation log is classified in accordance with display units set in advance;
determining a number of the axes on a basis of a number of the object and use the event data to generate the graph object in each of the display units; and
using the graph object in each of the display units to draw axes arranged in parallel as many as the number and a line representing a node-to-node connection relationship between two of the axes to perform screen display.

10. The display control method according to claim 6, further comprising:
using, in addition to the operation log, screen structure information including an application name, a window title, and information regarding all of operation targets included in the window to generate data indicating a layered structure for each of the nodes;
using the data to generate a graph object indicating a plurality of nodes expressed in a predetermined unit and a node-to-node connection relationship; and
using the graph object to draw two or more axes arranged in parallel and a line representing the node-to-node connection relationship corresponding to each of the operation targets to perform screen display.
